(19) United States
(12) Patent Application Publication
(10) Pub. No.: US 2003/0226025 A1
(43) Pub. Date: Dec. 4, 2003

(54) Data security method of storage media

(76) Inventors: Chanson Lin, Hsinchu (TW); Yu-Ting Chiu, Hsinchu (TW); Chih-Liang Yen, Hsinchu (TW); Ching-Hu Chen, Hsinchu (TW); Kuohong Wang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/200,283

(22) Filed: Jul. 23, 2002

(30) Foreign Application Priority Data
Jun. 4, 2002 (TW) 91111944

(51) Int. Cl. H04L 9/00

(52) U.S. Cl. 713/193

(57) ABSTRACT

The present invention provides a data security device and a data security method of storage media. The data security device comprises an interface decoder for receiving control instructions and data from a host computer. The interface decoder is connected to an encryption/decryption unit and a password check unit. When a user wants to access the security data region in the storage medium, the password check unit will check the inputted password. If the password is correct, the encryption/decryption unit is activated to encrypt the data to be secured into a ciphertext and decrypt the ciphertext into a plaintext. A storage data access control unit connected to the encryption/decryption unit and the storage medium is also provided to store the ciphertext and plaintext from the encryption/decryption unit into the storage medium and read the data in the storage medium into the decryption/decryption unit. The present invention encrypts the data to be secured in the storage medium to have the advantage of absolute security.

### FILED OF THE INVENTION

The present invention relates to a data security method and, more particularly, to a data security method capable of securing and hiding data in storage media.

### BACKGROUND OF THE INVENTION

In today's information age, almost all of people's information are transmitted and stored via computers. Computer's hard disks become centralized positions where private data like work reports, diaries, and electronic mails are stored. How to prevent these private domains from intentional or unintentional infringement of others becomes an important issue in today's software and hardware design.

Among conventional security software or hardware designs, the most commonly used is adopting the method of password check to protect the encrypted file. The system checks whether the input password is correct or not. If the input password is correct, the user can then access security data in the encrypted file in the storage medium. However, this kind of password check method does not encode and hide the data to be secured. Once a data stealer installs the storage medium storing the security data on a computer without the security software or hardware, he can then directly access the security data without inputting the code because the computer has no code check function. Therefore, the security data of user cannot be fully protected, and there is doubt that private documents or data be stolen or watched.

Accordingly, the present invention aims to propose a data security device and a data security method capable of fully securing and hiding the data to be secured in storage media.

### SUMMARY OF THE INVENTION

The primary object of the present invention is to propose a data security method, whereby data to be secured are scrambled to encode the data into a ciphertext so that the secured data cannot be decrypted before the host computer has not issued a security data unlocking instruction and the unlocking password has not been inputted or checked to be correct, thereby providing a complete and valid protection for the security data.

Another object of the present invention is to propose a data security method, whereby the existence of the security data region of a storage medium cannot be recognized before the host computer has not sent the inputted password to the data security device and whether the inputted password is correct or not has not been checked by the data security device, thereby fully hiding the security data region to prevent others from watching and stealing.

According to the present invention, a data security provides a data security device, which comprises an interface decoder, an encryption/decryption unit, a password check unit, and a storage data access control unit. The interface decoder is used to receive control instructions and data from a host computer. The encryption/decryption unit is connected to the interface decoder, and is used to encrypt the data to be secured into a ciphertext and decrypt the ciphertext into a plaintext. The password check unit is connected to the interface decoder and the encryption/decryption unit, and is used to store the password and check the inputted password from the host computer. The storage data access control unit is connected to the encryption/decryption unit and the storage medium, and is used to store the ciphertext and plaintext from the encryption/decryption unit into the storage medium and read the data in the storage medium into the encryption/decryption unit. When the data security device is in use, the host computer will issue a data region configuration instruction. After a configuration parameter is checked to be correct by the data security device, the public and security data regions are configured in the storage medium. When the host computer is turned on, the data security device only reports back the public region in the storage medium. When a user wants to access the security data region, he ought to input a password to the data security device. If the password is correct, the encryption/decryption unit is activated. When a data region is to be locked, the host computer will issue a security data locking instruction, and the data security device will check whether the locking parameter is correct. If the locking parameter is correct, the encryption/decryption unit is used to lock the data region to be secured in the storage medium. If a security data region is to be unlocked, the host computer will issue a security data unlocking instruction to the data security device, and the data security device will check in order whether an unlocking parameter and an unlocking password are correct or not. If they are correct, the encryption/decryption unit is used to unlock the security data region.

The various objects and advantages of the present invention will be more readily understood from the following detailed description when read in conjunction with the appended drawings, in which:

### BRIEF DESCRIPTION OF THE DRAWINGS

FIG. 1 is a structure block diagram of the present invention;

FIG. 2 is a diagram of the encryption process of the present invention; and

FIG. 3a to 3e show the flowchart of the data security method of the present invention.

### DETAILED DESCRIPTION OF THE PREFERRED EMBODIMENTS

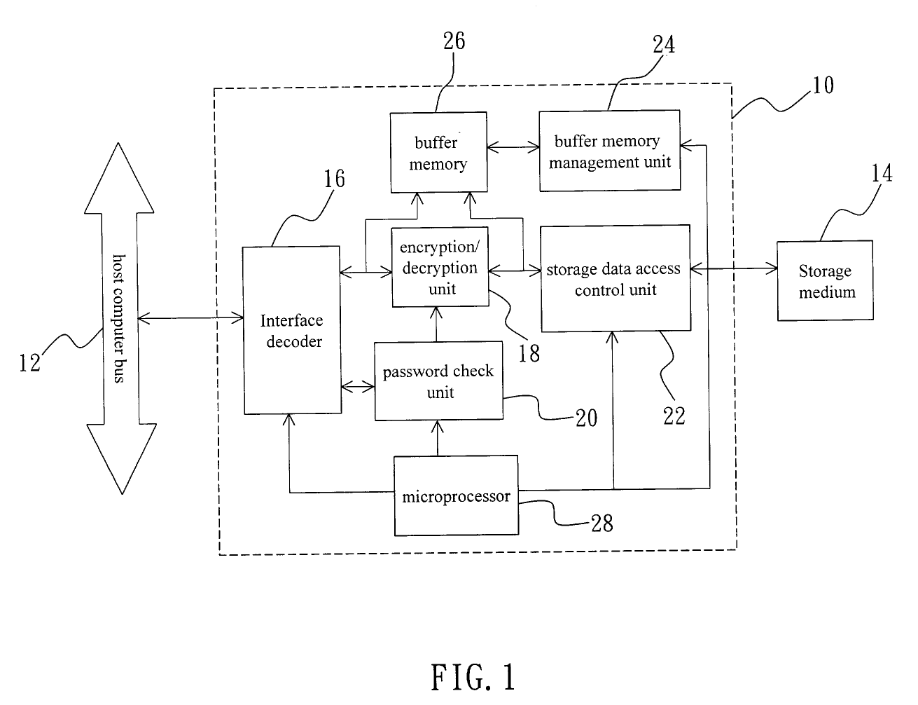

As shown in FIG. 1, a data security device 10 is connected between a host computer bus 12 and a storage medium 14. The data security device 10 comprises an interface decoder 16, an encryption/decryption unit 18, a password check unit 20, and a storage data access control unit 22. The interface decoder 16 is matched with the type of the host computer bus 12 and used to perform the actions of interface signal control, data transmission, command interpretation, and status report. The encryption/decryption unit 18 is connected to the interface decoder 16 to scramble data transmitted from the interface decoder 16 to be secured in data block way so as to encrypt the data into a ciphertext or reversely decrypt the ciphertext into a plaintext. The password check unit 20 is connected to the interface decoder 16 and the encryption/decryption unit 18, is used to store the password, check the inputted password, and determine the open level of the storage medium 14 according to the inputted password. The stored password can be first encrypted and then stored into the password check unit 20 to let the password be multiply protected. The storage data access control unit 22 is connected to the storage medium 14 and the encryption/decryption unit 18, and is used to store the ciphertext and plaintext from the encryption/decryption unit 18 into the storage medium 14 or read the data in the storage medium 14 to the encryption/decryption unit 18 for encryption and decryption.

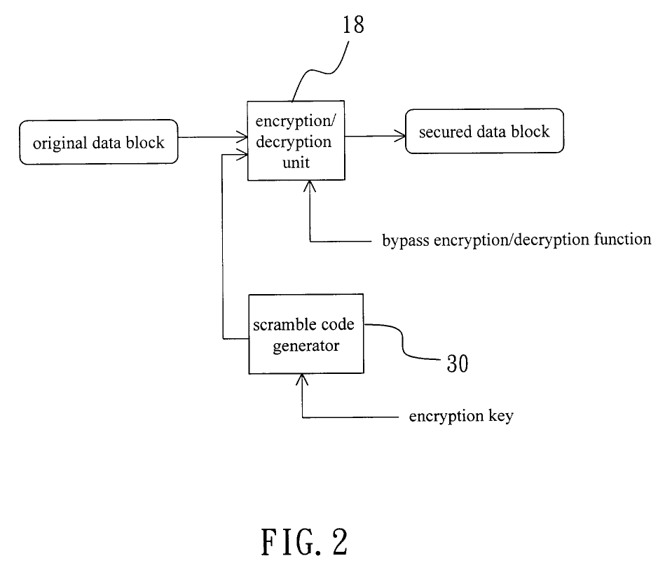

A buffer memory management unit 24 is disposed in the data security device 10. The buffer memory management unit 24 is connected to a buffer memory 26, which is connected to the interface decoder 16, the encryption/decryption unit 18, and the storage data access control unit 22. The buffer memory management unit 24 controls temporal storage and transmission of data of the buffer memory 26 to let data transmission be more stable and faster. A microprocessor 28 is connected to the interface decoder 16, the password check unit 20, the storage data access control unit 22, and the buffer memory management unit 24, and is used to control operational procedures of the whole device. As shown in FIG. 2, a scramble code generator 30 is further connected between the password check unit 20 and the encryption/decryption unit 18 so that an encryption key is inputted to the scramble code generator 30 to generate a specific scramble sequence during the encryption process. The encryption/decryption unit 18 encrypts an original data block to be secured into an encrypted data block according to the scramble sequence. The length of the scramble code can be as long as the data length of each data block. Using the encryption/decryption unit 18 to perform decryption is the reverse operation of the above encryption process. The encryption/decryption unit 18 also supports a bypass function, which lets public data directly bypass the action of the encryption/decryption unit 18.

The above host computer bus 12 can be of IDE, ATA, serial ATA, USB, PCI, SCSI, or IEEE 1394 type applicable to electronic equipments like personal computers, notebook computers, mobile phones, personal digital assistants (PDAs), or set-top boxes. The storage medium 14 can be selected among magnetic storage medium, optical storage medium, and solid-state memories. The storage medium 14 can be divided into a public data region and a security data region through the action of the data security device 10. The public data region is used to store not encrypted plaintexts. The security data region is used to store encrypted ciphertexts. The host computer cannot know the existence of ciphertexts before password check.

In the present invention, using the data security device 10 connected to the host computer bus 12 and the storage medium 14 for protection of data of the storage medium 14 comprises mainly the following steps.

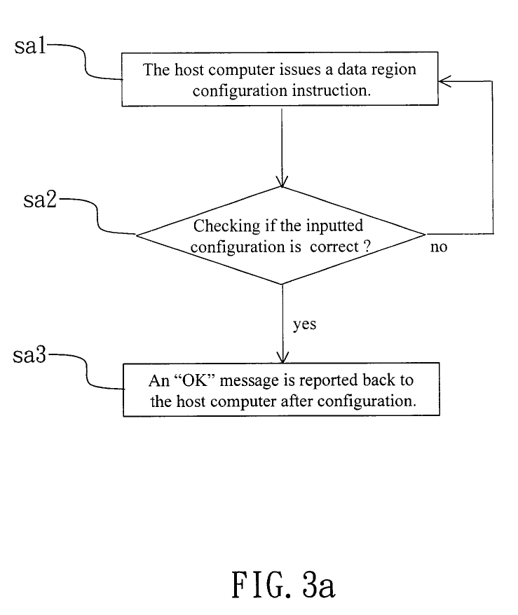

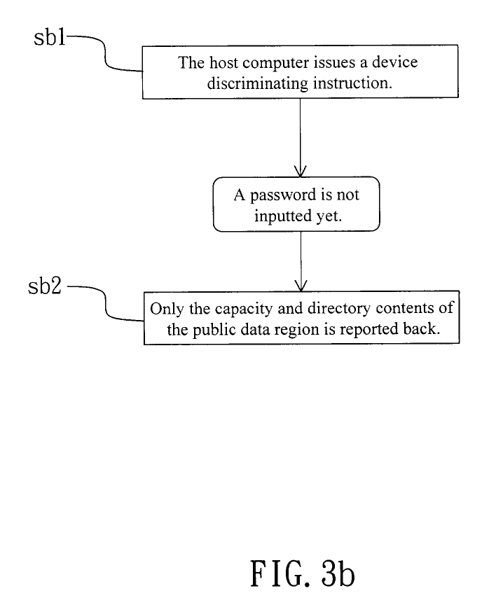

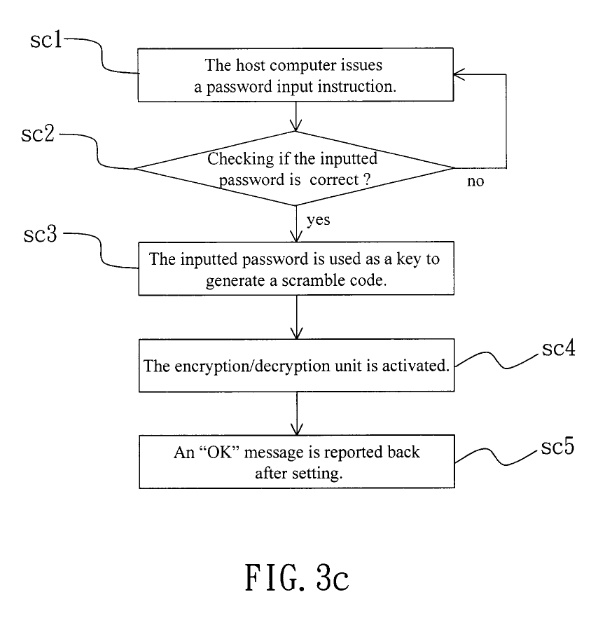

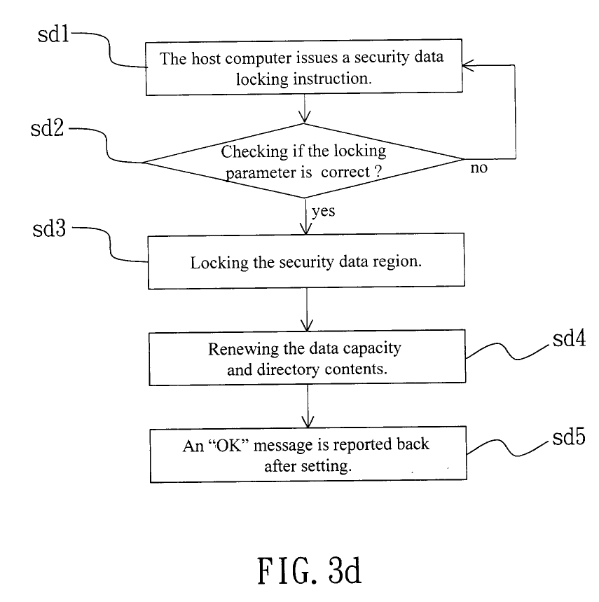

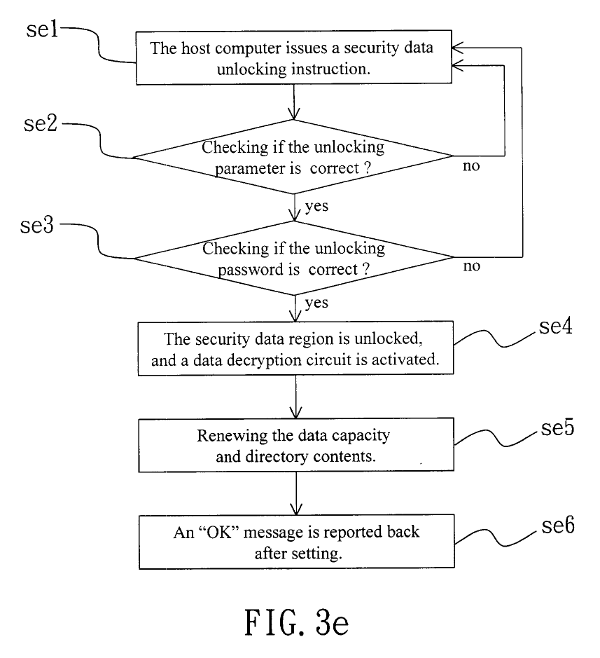

(a). Configuration of the public data region and the security data region of the storage medium: as shown in FIG. 3a, the host computer issues a data region configuration instruction to the data security device 10 (Step sa1), and the data security device 10 then checks the inputted configuration parameter from the host computer (Step sa2). If the configuration parameter is correct, configuration of the public data region and the security data region is performed, and an “OK” message is reported back after configuration (Step sa3). If the configuration parameter is wrong, Step sa1 is jumped back to without configuration of data regions, and the host computer issues a data region configuration instruction to the data security device 10 again.

(b). Boot procedure: as shown in FIG. 3b, when the host computer is booted each time, it issues a device discrimination instruction to the data security device 10 (Step sb1). Because there is no input password yet, the storage data access control unit 22 in the data security device 10 only reports back data capacity and directory contents of the public data region in the storage medium 14 to hide the security data region (Step sb2).

(c). Input procedure of encryption/decryption password: as shown in FIG. 3(c), the host computer issues a password input instruction to the data security device 10 (Step sc1). The data security device 10 is used to check the inputted password from the host computer (Step sc2). If the inputted password is correct, the inputted password is used as an encryption/decryption key (Step sc3), the encryption/decryption unit 18 is activated (Step sc4), and an “OK” message is then reported back to the host computer (Step sc5). If the inputted password is wrong, Step sc1 is jumped back to, and the host computer issues the password input instruction again.

(d). Data-locking procedure: as shown in FIG. 3d, when a user wants to lock a data region to be secured, the host computer will issue a security data locking instruction to the data security device 10 (Step sd1). The data security device 10 will check the inputted locking parameter from the host computer (Step sd2). If the locking parameter is correct, the encryption/decryption unit 18 locks the data region to be secured in the storage medium 14 (Step sd3), and renews the data capacity and directory contents of the storage medium 14 (Step sd4), and then reports an “OK” message to the host computer (Step sd5). If the locking parameter is wrong, Step sd1 is jumped back to, and the host computer issues the security data locking instruction to the data security device 10 again.

(e). Data-unlocking procedure: as shown in FIG. 3(e), when the user wants to unlock the secured data region, the host computer will issue a security data unlocking instruction to the data security device 10 (Step se1). The data security device 10 checks the inputted unlocking parameter from the host computer. If the decoding parameter is correct, an unlocking password is then checked. If the unlocking password is also correct, the security data region is unlocked and a data decryption circuit is simultaneously activated (Step se4), the data capacity and directory contents of the storage medium 14 are renewed (Step se5), and an “OK” message is then reported back to the host computer (Step se6). If either the unlocking parameter or the unlocking password is wrong, Step set is jumped back to, and the host computer issues the security data unlocking instruction to the data security device 10 again.

In the present invention, when the host computer has no password inputted to the data security device 10 or the inputted password is wrong, the security data region in the storage medium 14 will be hidden, hence having the advantage of preventing others from watching or stealing. Moreover, because the present invention scrambles and encrypts the data to be secured into a ciphertext, the security data cannot be decrypted and watched before the host computer issues the security data unlocking instruction to the data security device 10 and the unlocking parameter and the unlocking password are checked to be correct. Even if the storage medium is stolen, the stealer still cannot unlock the secured data in the storage medium 14, thereby providing a full and valid protection for the data in the storage medium.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

We claim:

1. A data security method of storage medium, comprising the steps of:
providing a data security device connected to a host computer and a storage medium, said data security device comprising an interface decoder, an encryption/decryption unit, a password check unit, and a storage data access control unit;
issuing a data region allocation instruction with said host computer to said data security device, which checks a configuration parameter from said host computer, performing configuration of at least a public data region and at least a security data region with said host computer if said configuration parameter is correct;
issuing a device discrimination instruction with said host computer to said data security device after being booted, only reporting back data capacity and directory contents of said public data region with said storage data access control unit of said data security device;
issuing a password input instruction with said host computer to said data security device when a user inputs a password to access said security data region, checking said password with said data security device, using said password as an encryption/decryption key and activating said encryption/decryption unit if said inputted password is correct;
issuing a security data locking instruction with said host computer to said data security device when the user wants to lock a data region to be secured, using said data security device to check a locking parameter, using said encryption/decryption unit to lock the data region to be secured in said storage medium and renewing the data capacity and directory contents of said storage medium if said locking parameter is correct; and
issuing a security data unlocking instruction with said host computer to said data security device when the user wants to unlock said security data region, using said data security device to check an unlocking parameter, continually checking an unlocking password if said unlocking parameter is correct, using said encryption/decryption unit to unlock said security data region and renewing the data capacity and directory contents of said storage medium if said unlocking password is also correct.

2. The data security method as claimed in claim 1, wherein said host computer can be selected among the group including personal computers, notebook computers, mobile phones, personal digital assistants, and set-top boxes.

3. The data security method as claimed in claim 1, wherein said storage medium can be selected among the group including magnetic storage media, optical storage media, and solid-state memories.

4. The data security method as claimed in claim 1, wherein said interface decoder is connected to said host computer bus to receive control instructions and data therefrom; said encryption/decryption unit connected to said interface decoder to encrypt said data to be secured from said host computer bus into a ciphertext and decrypt a ciphertext into a plaintext; said password check unit connected to said interface decoder and said encryption/decryption unit, said password check unit being used to store at least a password, check an inputted password, and determine the open level of data in said storage medium; said storage data access control unit connected to said encryption/decryption unit and said storage medium, said storage data access control unit being used to store ciphertexts and plaintexts from said encryption/decryption unit into said storage medium, and read data of said storage medium to said encryption/decryption unit.

5. The data security method as claimed in claim 1, further providing a microprocessor connected to said interface decoder, said password check unit, and said storage data access control unit to control operational procedures of said data security device.

6. The data security method as claimed in claim 1, further providing a buffer memory connected to said interface decoder, said encryption/decryption unit, and said storage data access control unit for temporal storage and transmission of data, and a buffer memory management unit is connected to said buffer memory to manage it.

7. The data security method as claimed in claim 4, wherein said host computer bus can be selected among the group of buses including IDE, ATA, serial ATA, USB, PCI, SCSI, and IEEE 1394.

8. The data security method as claimed in claim 1, wherein said encryption/decryption unit performs encryption and decryption in a unit of data block.

9. The data security method as claimed in claim 1, wherein said password stored in said password check unit is first encrypted and then stored.

10. The data security method as claimed in claim 4, further providing a scramble code generator for connecting between said password check unit and said encryption/decryption unit, said inputted password is scrambled by said scramble code generator to generate a scramble sequence to let said encryption/decryption unit perform encryption and decryption according to said scramble sequence.
